(19) United States
(12) Patent Application Publication
(10) Pub. No.: US 2014/0052587 A1
(43) Pub. Date: Feb. 20, 2014

(54) SOCIAL COMMERCE AGENT STORE REPLICATION

(71) Applicant: Zindigo, Inc., New York, NY (US)

(72) Inventors: MICHAEL BERECK, PALM BEACH GARDENS, FL (US); WAYDE GILCHRIST, WEST PALM BEACH, FL (US)

(73) Assignee: ZINDIGO, INC., New York, NY (US)

(21) Appl. No.: 13/967,785

(22) Filed: Aug. 15, 2013

Related U.S. Application Data
(60) Provisional application No. 61/683,512, filed on Aug. 15, 2012.

(51) Int. Cl. G06Q 30/06

(52) U.S. Cl. CPC G06Q 30/0641
USPC 705/27.1

(57) ABSTRACT

An online user visiting a social media web page provided on a social media platform and containing a third-party electronic shop application served by a registered social commerce platform is enabled by a shop replication link to embed a copy of the electronic shop application on the user's own social media page. The electronic shop application can provide user interactive buttons for buying or sharing favorable indications for products displayed on the social media web page. A user sharing indication may be captured by the social commerce platform and added to a favorites listing to be displayed on the user's social media web page. The replication link may also be adapted for use on a webpage of any electronic commerce platform to embed it in a webpage of an affiliate website, a blogsite, and/or a social media website.

### RELATED APPLICATION

This U.S. patent application claims the benefit of and expressly incorporates by reference all of the disclosure of U.S. Provisional Application No. 61/683,512 of the same inventors, entitled “Social Commerce Agent Store Replication”, filed Aug. 15, 2012.

### FIELD OF INVENTION

This U.S. patent application is directed to web-based commerce, and more specifically, to methods of embedding web-based commerce websites into social media web pages.

### BACKGROUND ART

Specialty merchandise brands face huge marketing challenges competing with major brands. Major brands are able to bid up the price of using keywords in search engine services, making search engine marketing an ineffective online marketing tool for specialty brands. Department stores mostly only carry the products from the major brands because those receive the most advertising. As a result, smaller brands, with higher quality and better-value products, are not able to reach consumers, and consumers may find it difficult to hunt for and locate specialty merchandise.

Social media offered through online websites has the potential to level the playing field for specialty brands. Viral social media marketing, where consumers spread the word to their friends about products they like, is developing to be more powerful than traditional ad-based marketing because consumers trust the opinions of their friends much more than advertisers.

Product brands have begun to market to users of social media platforms, such as the Facebook™ social media platform, by launching and promoting their social media pages and offering special promotions to users who “like” them and become connected to their brand. Product brands have also tried to directly monetize their social media presence by embedding an online store or links to an online store in their social media pages. Some examples of this are described in U.S. Pat. No. 8,417,577, and U.S. Patent Application Publication 2009/0055292.

However, most brands that have tried “social commerce” have failed to see an overall increase in their online sales revenues. The apparent reason for this is that consumers who buy online are already buying from the brands' standalone web based stores. What they see on Facebook™ social media is just a scaled-down version of the same store carrying the same products. Without an added value or incentive, consumers have not rewarded brands for their social commerce efforts.

### SUMMARY OF INVENTION

The present invention provides a means and method to enable a visitor (user) to embed a shop media page segment from a visited social media page on the user's own social media page. In a preferred embodiment of the invention, an electronic commerce (“ecommerce”) shop segment is contained in an inline frame (“iframe”) on a visited social media page, typically a social media page containing a shop segment for one or more products. Each ecommerce shop segment contains a replication link that enables a visitor (user) to replicate and embed a copy of the ecommerce shop segment on the user's own social media page, thereby enabling the user to become a social agent for enabling purchase of favorite products on a consumer level.

In a further embodiment, a social agent can customize their own social media page for recommendation of favorite products to friends and followers. Using a common sharing function provided on social media platforms, a user can indicate an affinity for a particular product item on their social media page, and have the item of indicated affinity captured and displayed in a favorites list on the user's social media web page.

These and other features of the invention will be more readily understood upon consideration of the attached drawings, described below, with reference to the following detailed description of presently-preferred and other embodiments of the invention.

### BRIEF DESCRIPTION OF DRAWINGS

FIG. 1 shows an example of a social media page containing an embedded electronic commerce shop segment;

FIG. 2 shows a means for social commerce agent store replication in accordance with a preferred embodiment of the present invention;

FIG. 3 shows an example of a user's social media page containing an embedded copy of an electronic commerce shop segment that has been replicated from a visited social media page;

FIG. 4 shows a flow chart illustrating the steps comprising an example of social commerce agent store replication and embedding process for a preferred embodiment of the present invention;

FIG. 5 shows a flow chart illustrating the steps comprising an example whereby products selected as the social agent's favorites from visited social media pages are captured for display on the social agent's favorites page;

FIG. 6 shows a flow chart illustrating the steps comprising an example whereby products selected as the social agent's favorites from visited social media pages are displayed in a summary list on the social agent's favorites page;

FIG. 7 shows an example of a display of a social agent's favorites page;

FIG. 8 shows a flow chart illustrating the steps comprising an example whereby a social agent's previously-indicated favorite product is removed from the social agent's favorites page;

FIG. 9 shows a flow chart illustrating the steps comprising an example of the replication link creation process; and

FIG. 10 illustrates a typical user's social media page containing a “Visit My Shop” button to display an ecommerce shop segment replicated as a posting by the user.

### DETAILED DESCRIPTION OF EMBODIMENTS OF INVENTION

In the following detailed description, certain preferred embodiments are described as illustrations of the invention in specific computer-implemented services or application environments in order to provide a thorough understanding of the present invention. Common methods, procedures, components, or functions for such applications, networks, and/or services or environments which are commonly known to persons of ordinary skill in the field of the invention are not described in detail so as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

The computer-implemented services or application environments in the detailed description which follows may be presented in terms of certain procedures, steps, logic blocks, processing, and other symbolic representations of functional operations implemented on a computer device by a computer program operable on data bits stored within a computer memory. These descriptions and representations are intended to be understood by those skilled in the data processing arts. A program procedure, computer-executed step, logic block, process, etc., is described as a self-consistent sequence of steps or instructions leading to a desired end result, such as providing a tangible computer output, such as an alarm, status indicator, or data display, or implemented by computer to result in physical manipulations of physical quantities or materials. Usually, though not necessarily, such tangible computer-implemented output may take the form of electrical outputs or signals capable of being displayed, stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following descriptions, terms such as “processing” or “computing” or “translating” or “calculating” or “determining” or “displaying” or “recognizing” or the like, refer to the action and processes of a computer system, or analogous electronic computing device, that manipulates and transforms data represented as physical (electronic) quantities within the computer system's registers and memories into other data similarly represented as physical quantities within the computer system memories or registers or other such information storage, transmission or display devices.

A computer or computing resource commonly includes one or more input devices electronically coupled to a processor for executing one or more computer programs for producing an intended computing output. The computer is typically connected as a computing resource and/or communications device on a network with other computer systems. The networked computer systems may be of different types, such as remote PCs, master servers, network servers, and mobile client devices connected via a wired, wireless, or mobile communications network.

The term “Internet” refers to a structure of global networks connecting a universe of users via a common or industry-standard (TCP/IP) protocol. Users having a connection to the Internet commonly use browsers on their computers or client devices to connect to websites maintained on web servers that provide informational content or business processes to users. The Internet can also be connected to other networks using different data handling protocols through a gateway or system interface, such as wireless gateways using the industry-standard protocols to connect Internet websites to wireless data networks for wireless data devices.

The Internet is an integral part of daily commerce conducted between online consumers (users) and online service providers. Consumer commerce transactions that occur over the Internet are collectively known as “electronic commerce.” The current model for electronic commerce typically involves a user visiting the website of an online service provider such as that of an online store, and engaging in a one-to-one transaction in which the user selects one or more products and/or services and pays for them through a payment facility provided by the service provider, then the service provider fulfills the transaction ordered.

Social media platforms on the Internet are commonly used by users to display information about themselves, their preferences, and their interests on their social media pages to share with friends and followers. Such social media information sharing can include viewing a user's favorites shopping information on a user's social media page. An example of viewing shopping information on products bought by a user, which is captured by a network-based commerce server and retrieved therefrom for viewing, on the user's social media page is disclosed in U.S. Pat. No. 8,417,577, entitled “Viewing Shopping Information on a Network Based Social Platform”, which is incorporated by reference herein for an explanation of background of web server technology used for social commerce.

Social media platforms commonly provide functions for use on social media pages such as links to store websites to facilitate a purchase of a recommended product. An example of a method and system to facilitate purchase of an item on a store website by providing a link on a social media page that is associated with the item for sale on the store website is described in U.S. Patent Application Publication 2009/0055292, entitled “Methods and Systems to Facilitate a Purchase of an Item on a Network-Based Marketplace, which is incorporated by reference herein for an explanation of background of web server technology used for social commerce.

Many social media platforms, such as Facebook™ and Google+™, and blog authoring platforms, such as Wordpress™, provide Application Programming Interface (API) tools to allow third-party developers to extend the base functionality of the social media platform by creating their own customized applications that can be installed by users on their social media pages. Such APIs commonly used by social media platforms are well-known to those familiar with the ecommerce industry and need not be described in detail herein.

Turning now in the following detailed description having reference to the drawings, in which similar reference characters denote similar elements throughout the views, a preferred embodiment of a means and method to enable a visitor (user) to embed a shop media page segment from a shop's social media page on the user's own social media page is explained.

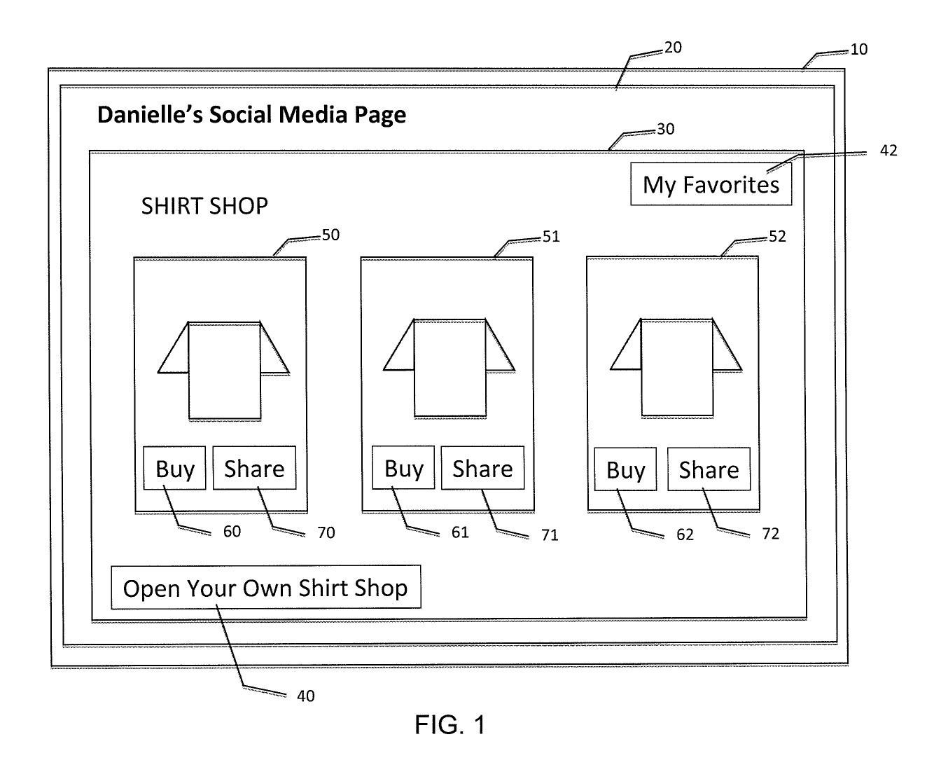

Referring to FIG. 1, an Internet browser window 10 is connected to a social media service and displays a social media page 20 of a store called “Danielle's” in this example. An electronic commerce shop 30 is embedded in Danielle's social media page 20 using inline frame (“iframe”) or similar technology. As is well known in the field, an “iframe” element (inline frame) is a nested browsing function specified by World Wide Web Consortium at http://www.w3.org/wiki/HTML/Elements/iframe.

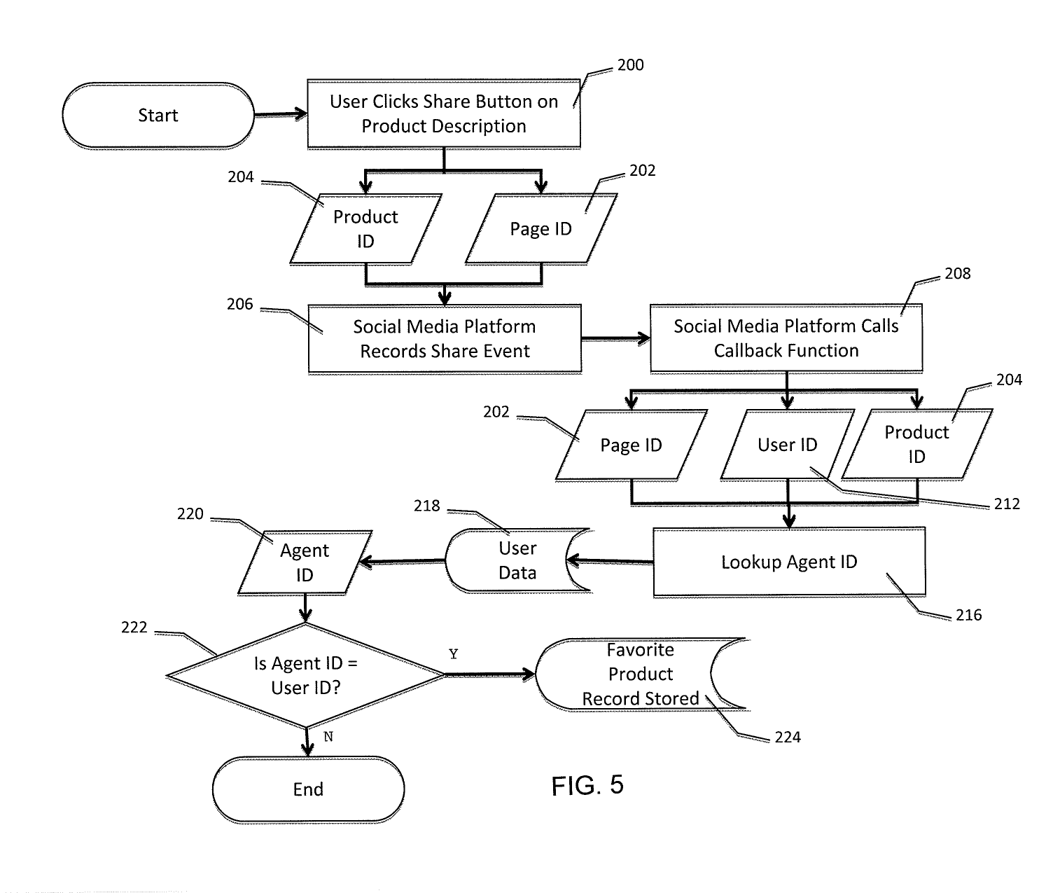

The electronic commerce shop 30 comprises a Shop replication link 40, a “My Favorites” link 42, and a plurality of product descriptions 50, 51, and 52, each comprising respective “Buy” buttons 60, 61, and 62, and “Share” buttons 70, 71, and 72. Shop replication link 40 enables a visitor (user) to embed the shop social media page segment on the user's own social media page. In a preferred embodiment, the shop replication link 40 is a uniform resource locator (URL) that redirects the user's browser window to an agent sign-up form where the URL for the user's own social media page can be inputted. Replication link 40 includes a unique agent id indicating the agent for the currently-displayed shop 30, who is also the administrator for the shop social media page 20. “My Favorites” link 42 is a URL that includes the agent id and redirects the user's browser window to the agent's favorites page. Buy buttons 60, 61, and 62 trigger a product purchase process, which will not be described herein as it typical and well known in the current art of electronic commerce. Share buttons 70, 71, and 72 trigger the agent favorites process further described with respect to FIG. 5.

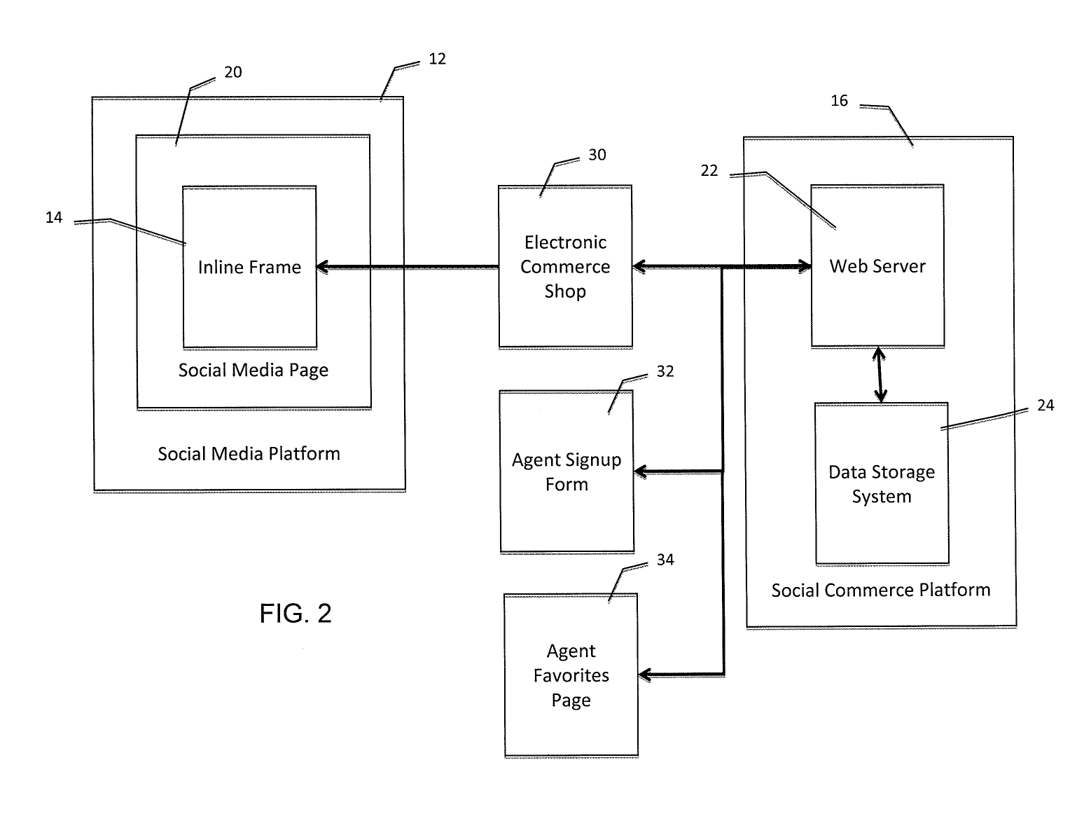

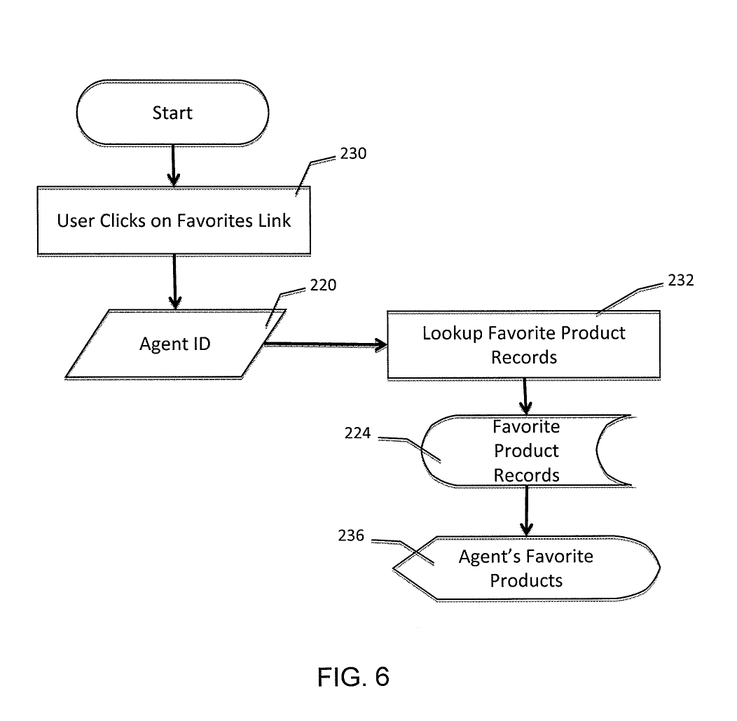

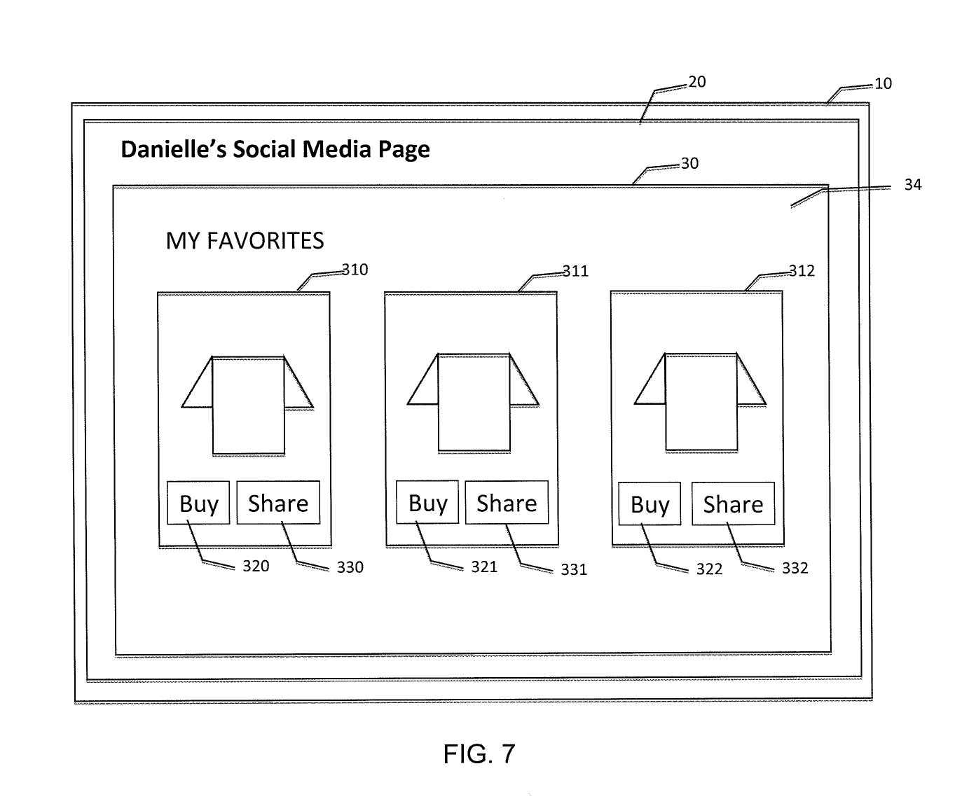

FIG. 2 illustrates the general system architecture for implementation of a preferred embodiment of the present invention. As is well known in the field, a social media platform 12 is used to provide social media services to a plurality of user members via respective user pages viewed and interacted with through their browsers. Social media platform 12 provides a social media page 20 that may be visited by members of the social media platform through their web browser 10 shown in FIG. 1. The social media platform 12 also enables third-party developers to offer various service applications (“apps”) for various services and other interactivity functions of interest to user members. In the preferred embodiment, a social commerce agent application is provided on the social media platform 12 by a third-party application for electronic commerce from a social commerce platform 16, which comprises a web server 22 running an electronic commerce shop application 30 in conjunction with a data storage system 24, typically a SQL database. For a store or other user member that has registered to use the electronic commerce shop application 30, the social commerce platform 16 serves up a social media page 20 for the registered user member on the social media platform 12 containing an inline frame 14 that displays an electronic commerce shop application page served from the social commerce platform 16. The social commerce platform 16 creates the electronic commerce shop application 30 that is embedded by social media platform 12 into inline frame 14 and also provides the agent signup form 32 used in the electronic shop replication and embedding process shown in FIGS. 5 and 6 and the agent favorites page 34 shown in FIG. 7.

The relationship between social media platform 12 and social commerce platform 16 is typically created by registering the social media platform 12 to offer an application provided on the social commerce platform 16, as well known in the industry. Social commerce platforms, such as Facebook™ social media, provide API functions that enable extending their platform for use by third-party applications. The application, specifically an electronic commerce shop 30, is rendered and provided by the social commerce platform 16. The URL for the electronic shop 30 is registered on the social media platform 12. The registration process allows the social media platform 12 to embed the social commerce shop 30 into the inline frame 14 by specifying the source for the inline frame as the URL for the electronic shop 30 hosted on social commerce platform 16.

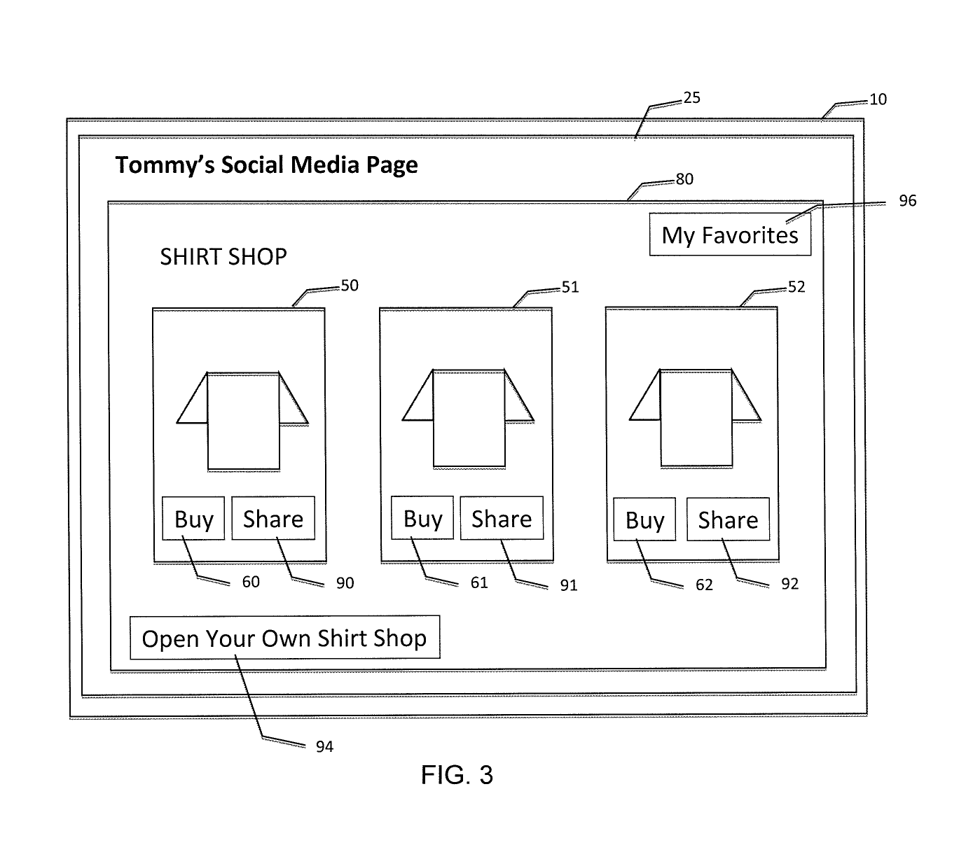

FIG. 3 depicts browser window 10 pointed to the user's social media page 25, called “Tommy's” in this example, which has embedded in it a copy of the electronic shop 80 activated by the Shop replication link 40 from Danielle's page for the electronic shop 30 depicted in FIG. 1. Like the electronic shop 30, Tommy's copy of the electronic shop 80 contains the plurality of product descriptions 50, 51, and 52, each comprising respective “Buy” buttons 60, 61, and 62. Tommy's replication link 94 and favorites link 96 contain the unique agent id for the current user Tommy, who is now a logical child of the Danielle agent for shop 30. Share buttons 90, 91, and 92 trigger the agent favorites process for the child agent.

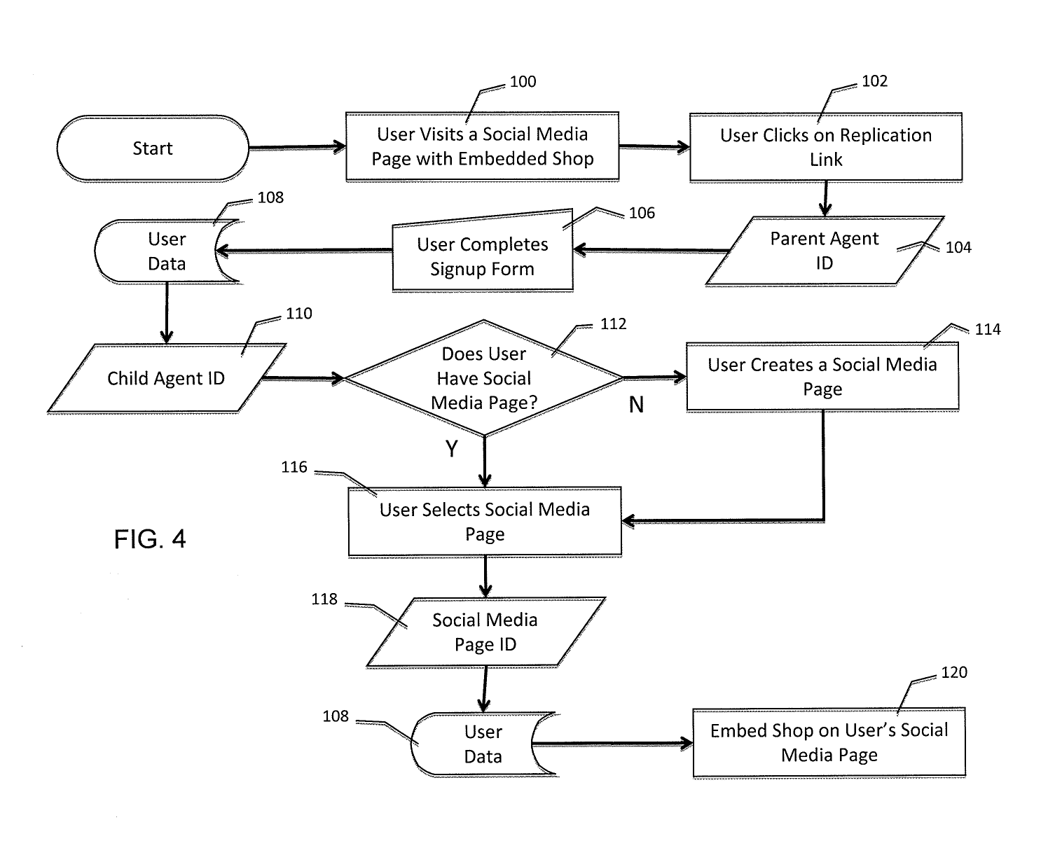

FIG. 4 shows a flow chart illustrating the steps comprising the electronic shop replication and embedding process. The first step 100 occurs when the Internet user points their web browser 10 to the social media page 20 containing an ecommerce shop segment 30 as illustrated in FIG. 1. For the second step 102, the user clicks on the shop replication link 40. The replication link includes a parent agent id 104 that uniquely defines the parent agent for the shop. The parent agent is the owner and administrator of the social media page 20 containing the shop 30. In step 106 the browser window 10 displays, and the user completes, the agent signup form 32. The user data 108 from the signup form 32 is then saved in the data storage system 24 which generates and returns a new child agent id 110 for the user. In the next step 112, the user is asked whether the user has a social media page that is to contain the shop copy. If the user does not have a social media page for the shop copy, then the user is stepped through a process 114 to create a social media page. If the user already has a suitable social media page, they may skip step 114 and proceed to step 116 where they select their social media page (Tommy's social media page 25) to contain the shop copy (Tommy's shop copy 80). When this selection is made, the unique id 118 representing the social media page is added to the user data record 108. Social media platforms typically provide the capability to install applications on their pages through an application programming interface (API). Finally, in step 120 the new copy of the shop 80 is embedded into the user's selected social media page 25 by calling the applicable methods and functions of the API for the social media platform hosting the social media page 25. On Facebook™ social media, for example, the application is added to a user member's page by appending to the tabs element of a page object through the Graph API. Specifically, the social commerce platform 12 issues an HTTP POST request to PAGE_ID/tabs with a Page Access Token (reference: https://developers.facebook.com/docs/reference/api/page/#tabs).

FIGS. 5 and 6 are flow charts illustrating the steps of the agent favorites process. For the first step 200 the user visiting a shop on a social media page, such as Danielle's shop 30 shown in FIG. 1, clicks on a Share button 70, 71, or 72 for a product in the visited shop. Clicking on one of the Share buttons 70, 71, or 72 invokes the sharing function of the social media platform 12. Typically this is accomplished through the use of a social plugin provided by the social media platform 12. On Facebook™ social media, for example, share buttons 70,71,72 are implemented using the “Like” button plugin, for example, as described at https://developers.facebook.com/docs/reference/plugins/like/. The product id 204 and social media page id 202 are passed to the social media platform 12 that records the share event in step 206. In step 208 social media platform 12 then invokes a callback function on the social commerce platform web server 22, passing the social media page id 202, user id 212 for the current user, and product id 204 for the shared product. On Facebook™ social media, for example, product id 204 would be placed in the “ref parameter for the “Like” button. This parameter is passed back to the social commerce platform web server 22 as an input parameter to the “Callback” function, which is invoked by the Facebook platform when the “edge.create” event is fired. The procedure for implementing this functionality is described at https://developers.facebook.com/docs/reference/javascript/FB.Event.subscribe/. An example of pseudocode for the social commerce server 16 using the “Callback” function in step 208 in FIG. 5 is provided in the appended Table I.

In step 216 the agent id 220 for the shop 30 is looked up using the page id 202 from the saved user data 218. If the agent id 220 for the shop matches the current user id 212, then the favorite product record 224 made up of the agent id 220 and product id 204 is created in the data storage system 24. This records the product indicated for sharing as a “favorite” of the agent administering the shop 30.

In the flow chart shown in FIG. 6, a user visiting the social media page 20 of FIG. 1 clicks on the “My Favorites” link 42 in step 230. The “My Favorites” link URL in step 230 includes the agent id 220 for the shop 30. Clicking on “My Favorites” link in step 230 redirects the browser window 10 to the agent's favorites page on the social commerce web server 22. The agent's “My Favorites” page is dynamically generated in step 232 that retrieves the favorites product records 224 from the data storage system 24 and displays the product data for each favorite product in step 236.

FIG. 7 shows a typical representation of the “My Favorites” page 34 for the agent Danielle's electronic shop 30 of FIG. 1. The page contains a plurality of product descriptions 310, 311, 312 representing the favorite products for the agent of shop 30. Each product description will typically contain respective Buy buttons 320, 321, and 322 and Share buttons 330, 331, and 332.

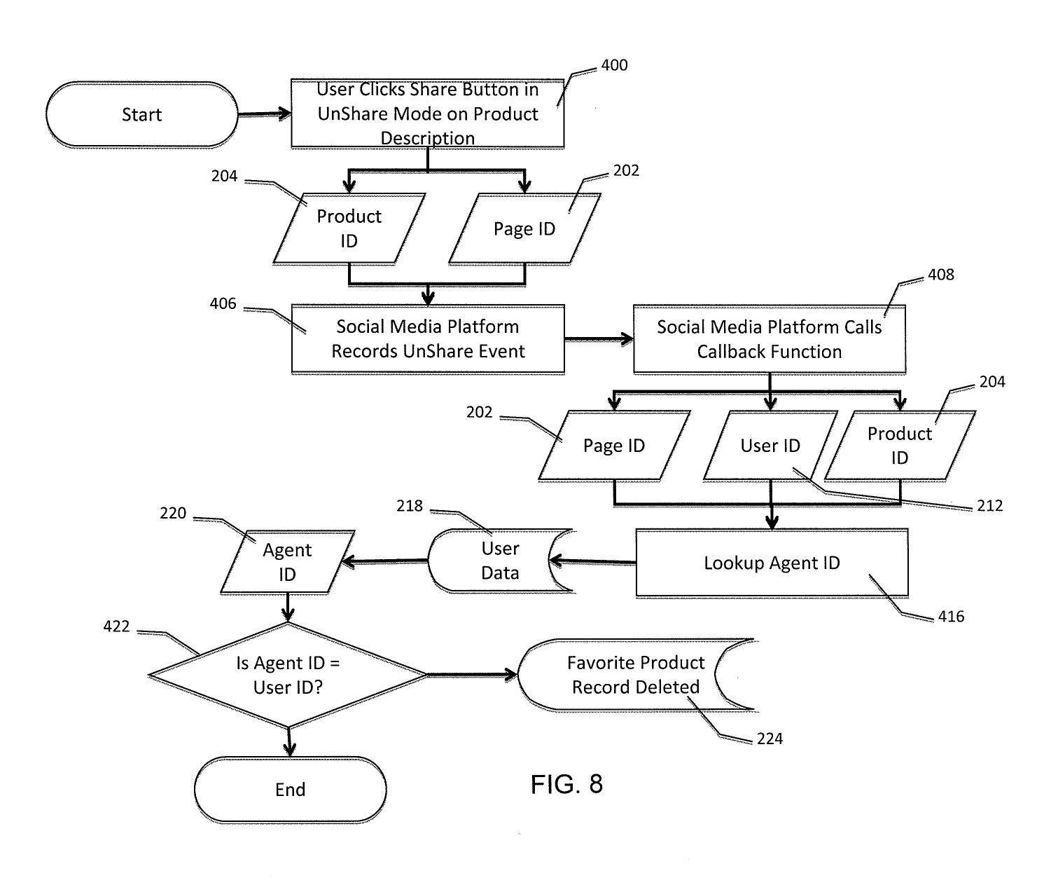

Once the user has clicked on a Share button, the social media platform 12 will typically provide a means to undo the share event by clicking on the share button a second time. The social media platform 12 recognizes that this button has already been clicked and is in un-share or “unlike” mode. The flow chart in FIG. 8 illustrates the process of removing an item from an agent's “My Favorites” page by clicking on a Share button for a product that has already been shared. For the first step 400 the agent for the shop, such as Danielle's electronic shop 30 shown in FIG. 1, clicks on a Share button 330, 331, or 332 on the “My Favorites” page 34 in their own shop 30. Clicking on one of the Share buttons invokes the un-sharing function of the social media platform 12. The product id 204 and social media page id 202 are passed to the social media platform 12 that records the un-share event in step 406. In step 408 social media platform 12 then invokes a callback function on the social commerce platform web server 22, passing the social media page id 202, user id 212 for the current user, and product id 204 for the shared product. In step 416 the agent id 220 for the shop 30 is looked up using the page id 202 from the saved user data 218. If the agent id 220 for the shop matches the current user id 212, then the favorite product record 224 made up of the agent id 220 and product id 204 is deleted from the data storage system 24.

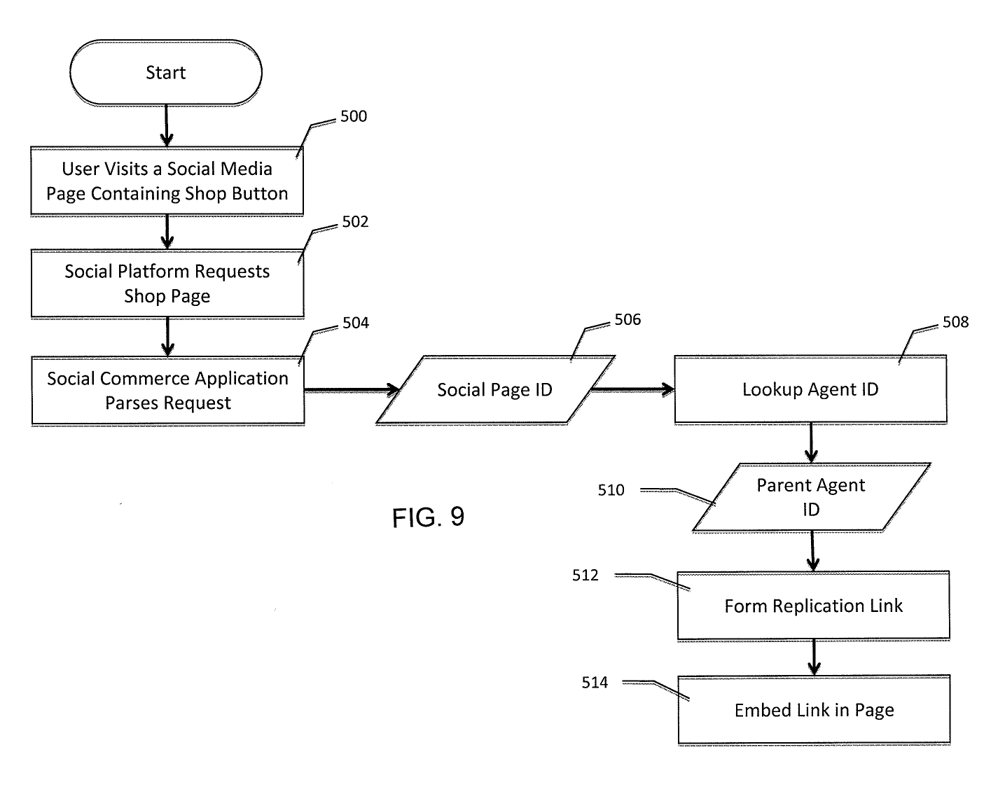

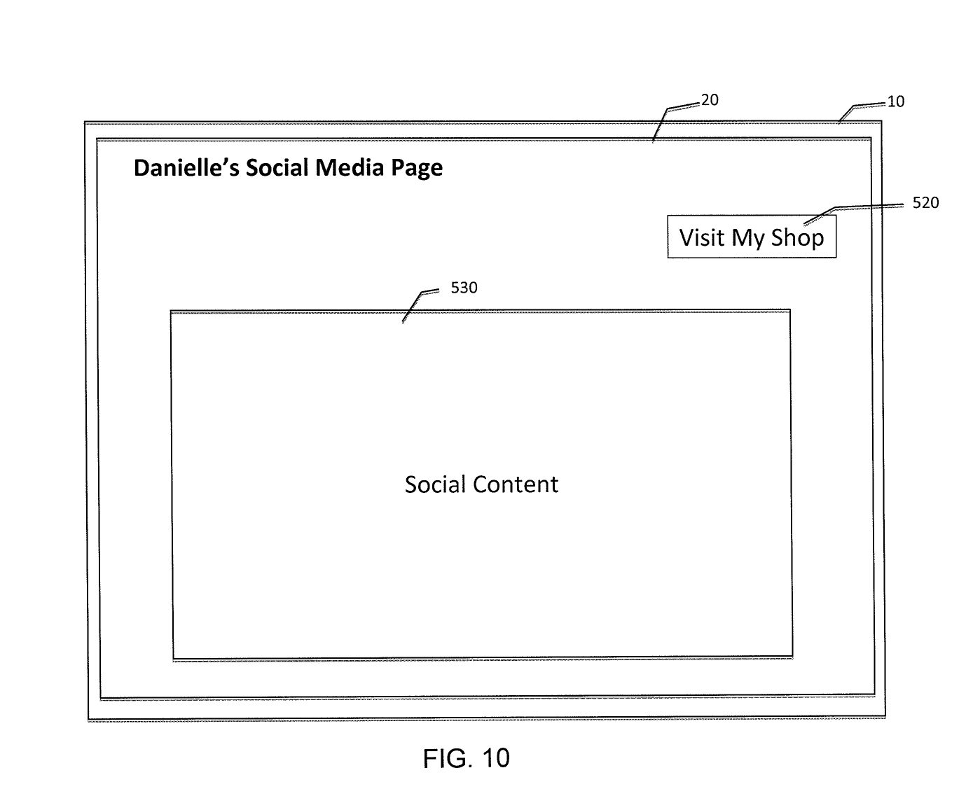

FIG. 9 shows a flow chart illustrating the steps comprising the replication link creation process. FIG. 10 illustrates a typical social media page, such as Danielle's social media page 20 in FIG. 1, which contains a “Visit My Shop” button 520 as well as other social content 530 which typically comprises posts by the social media page owner. The first step 500 in FIG. 9 occurs when a user visits a social media page 20. For the next step 502 the user clicks on “Visit My Shop” button 520, and the social media platform 12 requests the shop page from the social commerce platform 16. The social commerce web server 22 parses the request in step 504 and extracts the unique page id 506 for the social media page 20. Typically the request sent by the social media platform 12 is signed with a shared authentication key that is known by the social media platform and social commerce application, so the request can be authenticated. An example of pseudocode for the social commerce web server creating a replication link in step 504 of FIG. 9 is provided in the appended Table II.

In step 508, the social commerce web server 22 looks up the agent id 510 from the data storage system 24 using page id 506 as the key. The replication link 40 is formed by appending the agent id 510 to the end of the URL for the agent signup form 32. In the final step 514 the replication link 40 is added to the HTML code for the electronic shop 30 which is shown in the social media page 20.

An alternative embodiment for a shop replication link can include embedding it with electronic commerce shops on non-social media platforms such as blogs and traditional electronic commerce affiliate sites in an equivalent manner as described above. Wordpress™ is a common example of a blog platform where content from a third-party commerce application platform may be embedded into an inline frame for display on the blog platform. In such an embodiment, the blog would provide the ecommerce application display (in place of the social media platform 12 in FIG. 1) on a member's blog page (in place of the social media page 20 in FIG. 1). The blog author would be the agent for the third-party ecommerce application (in place of the electronic commerce shop 30 in FIG. 1). The blog author would need to embed the third-party ecommerce application on the blog page, which can be accomplished manually, if not enabled through APIs of the blog platform, by entering the URL for the third-party ecommerce application into a sign-up form to be displayed on the blog platform. The URL would include either the blog owner's unique agent id, or a unique name for the shop, so that a replication link can be formed and added to the third-party ecommerce application (in a manner similar to that shown in FIG. 9). Typically, the content of the agent signup form would include instructions on how to embed a copy of the third-party ecommerce application on a visitor's designated blog page and provide the URL for the third-party ecommerce application with the new unique agent id for the visitor-owner as a child agent in the ecommerce application.

In a similar manner, a shop replication link can be embedded with a third-party ecommerce application for replication of the electronic shop on any other electronic commerce platform. Amazon™ is an example of a conventional electronic commerce platform that uses affiliate sites to sell their products outside of the Amazon web site. Typically, plugin code is given to an affiliate to embed into a web page not on the Amazon platform. A platform such as Amazon could adapt the invention as disclosed for incorporating a shop replication link into their plugin code. An electronic commerce shop application embedded with a replication link in a page of a website for an electronic commerce platform such as Amazon can thus be replicated on an affiliate website or other ecommerce website. In another marketing approach, a replication link embedded with an electronic commerce shop application in an ecommerce webpage could be replicated on a social media web page of an authorized child-agent of the agent for the ecommerce webpage.

The shop replication link as disclosed hereon can provide a high value-added revenue model for a third-party social commerce platform. By encouraging user members of a social media platform such as Facebook™ to replicate electronic shops from visited social media pages into their social media pages, the agent-to-child-agent replication can promote a viral marketing reach for a product or service to become popularized. The social commerce platform can track and earn commissions and/or referral fees from ecommerce vendors for sales revenues generated through “Buy” transactions engaged by users of the third-party ecommerce application on the social media platform.

The business advantages of the invention may also be derived when incorporated into an ecommerce website for replicative embedding into any ecommerce affiliate programs. Affiliate programs, such as the one managed by Amazon, are common in the industry. In a typical affiliate program, an affiliate is awarded a percentage of the sales made on their web site, or in case of the preferred embodiment herein, on their social media pages. This encourages affiliates to actively promote products in electronic commerce shops on their web pages. In addition, affiliates may be awarded a percentage of sales made on pages owned by individuals who replicated copies of the electronic shop by clicking on the replication link. This encourages affiliates to actively recruit other affiliates into the affiliate program. The social commerce platform can track and process all sales transactions generated through affiliate electronic commerce shops replicated by replication links, and thereby earn a percentage of generated sales. Another variation is to incorporate a drop-ship model of fulfillment with manufacturers. In this variation, the manufacturers fulfill the orders and receive a percentage of the sales transaction to pay for the products.

The foregoing is considered as illustrative only of the principles of the invention. Further, since numerous modifications and changes will readily occur to those skilled in the art, the scope of the invention is not to be deemed limited to the embodiments, construction and/or mode of operation shown and described. Accordingly, all modifications and equivalents that would readily occur to those skilled in the art should be deemed encompassed within the scope of the invention, as defined in the following claims.

TABLE I
PSEUDOCODE FOR SERVER ADDING SHARE
RESPONSE TO FAVORITES:
Reference: Figure 5 (step 208)

```
CALL AgentLike with Page ID, User ID, and Product ID :
    READ Agent ID from STORAGE Agents with Page ID
    IF Agent ID = User ID THEN
        STORE Product ID with Page ID and User ID
    END IF
```

TABLE II
PSEUDOCODE FOR SERVER CREATING
SHOP REPLICATION LINK:
Reference: Figure 9 (step 504)

OBTAIN Request for Social Commerce Shop

PARSE Page ID from Request
READ Agent ID from STORAGE Agents with Page ID
SET Replication Link = Request Domain + Agent ID
SET Page Output = Page + Replication Link
DISPLAY Page Output

1. A method of replicating via a social commerce platform an electronic commerce shop application that is to be embedded in social media pages of user members on a social media platform, comprising:
a. providing via the social commerce platform a third-party electronic commerce shop application to be registered with the social media platform in order to enable display of the electronic commerce shop application embedded within social media web pages of user members on the social media platform;
b. providing via the social commerce platform a first replication link with the electronic commerce shop application to be embedded within a first social media web page on the social media platform, wherein the first replication link is configured to link to the social commerce platform by referencing a uniform resource locator for the electronic commerce shop application maintained by the social commerce platform; and
c. upon a user member clicking on the first replication link with the electronic commerce shop application on the first social media web page on the social media platform, generating via the social commerce platform a second replication link with the electronic commerce shop application to be embedded within a second social media web page on the social media platform designated by the user member, wherein the second replication link references the uniform resource locator for the electronic commerce shop application maintained by the social commerce platform so that it can be used to further replicate the electronic commerce shop application maintained by the social commerce platform on other social media pages of other user members on the social media platform.

2. The method of claim 1, wherein the electronic commerce shop application is served by the social commerce platform when registered with the social media platform to be displayed in an inline frame of a social media web page on the social media platform.

3. The method of claim 2, wherein the electronic commerce shop application served by the social commerce platform when registered with the social media platform is configured to wrap one or more user interactive functions of the social media platform into the display in the inline frame of a social media web page on the social media platform.

4. The method of claim 1, wherein the electronic commerce shop application is configured to provide a display in a social media web page on the social media platform of an electronic commerce shop for one or more products.

5. The method of claim 4, wherein the electronic commerce shop application is configured to provide with the display of the electronic commerce shop in the social media web page on the social media platform a user interactive button to enable a visitor to buy a displayed product.

6. The method of claim 4, wherein the electronic commerce shop application is configured to provide with the display of the electronic commerce shop a user interactive button to enable a visitor to share a favorable indication by the user member for a displayed product with other user members on the social media platform.

7. The method of claim 6, wherein the electronic commerce shop application is configured to capture the favorable indication shared by the user member for the displayed product and add the favorable indication for the displayed product to a favorites listing for the user member to be displayed with the display of the electronic commerce shop in the social media web page of the user member.

8. The method of claim 1, wherein the electronic commerce shop application of the social commerce platform when registered with the social media platform is configured to serve up a display of an agent signup form on the first social media web page for a user member visiting the first social media web page to designate a second social media web page on the social media platform owned by the user member for replication of the embedded electronic commerce shop application.

9. The method of claim 8, wherein the first replication link for the first social media webpage references a unique identifier for the owner of said first social media web page, and the second replication link for the designated second social media webpage is assigned a unique identifier for the user member to be designated as owner of said second social media web page.

10. The method of claim 8, wherein the first replication link for the first social media webpage references the owner of said first social media web page as agent of the embedded electronic commerce shop application, and the second replication link for the designated second social media webpage references the user member as child-agent of the electronic commerce shop application to be embedded on said second social media web page.

11. A method of replicating via a social commerce platform an electronic commerce shop application that is to be embedded in a webpage of an electronic commerce platform, comprising:
a. providing via the social commerce platform a third-party electronic commerce shop application to be registered with the electronic commerce platform in order to enable display of the electronic commerce shop application embedded within a webpage of the electronic commerce platform;
b. providing via the social commerce platform a first replication link with the electronic commerce shop application to be embedded within the webpage of the electronic commerce platform, wherein the first replication link is configured to link to the social commerce platform by referencing a uniform resource locator for the electronic commerce shop application maintained by the social commerce platform; and
c. upon a visitor to the webpage of the electronic commerce platform clicking on the first replication link provided with the electronic commerce shop application, generating via the social commerce platform a second replication link with the electronic commerce shop application to be embedded within another webpage of an electronic commerce platform so that it can be used to further replicate the electronic commerce shop application on other webpages of other electronic commerce platforms.

12. The method of claim 11, wherein the electronic commerce shop application is served by the social commerce platform when registered with the electronic commerce platform to be displayed in an inline frame of the webpage on the electronic commerce platform.

13. The method of claim 11, wherein the electronic commerce shop application served by the social commerce platform when registered with the electronic commerce platform is configured to generate the second replication link with the electronic commerce shop application to be embedded within a webpage of an affiliate electronic commerce platform.

14. The method of claim 11, wherein the electronic commerce shop application served by the social commerce platform when registered with the electronic commerce platform is configured to generate the second replication link with the electronic commerce shop application to be embedded within a webpage of a blogsite enabled as an electronic commerce platform.

15. The method of claim 11, wherein the electronic commerce shop application served by the social commerce platform when registered with the electronic commerce platform is configured to generate the second replication link with the electronic commerce shop application to be embedded within a social media webpage of a social media platform.

16. A system for replicating via a social commerce platform an electronic commerce shop application that is to be embedded in social media pages of user members on a social media platform, comprising:
a. the social commerce platform being configured to serve up a third-party electronic commerce shop application to be registered with the social media platform in order to enable display of the electronic commerce shop application embedded within social media web pages of user members on the social media platform;
b. the social commerce platform being configured to display a first replication link with the electronic commerce shop application to be embedded within a first social media web page on the social media platform, wherein the first replication link is configured to link to the social commerce platform by referencing a uniform resource locator for the electronic commerce shop application maintained by the social commerce platform; and
c. upon a user member clicking on the first replication link with the electronic commerce shop application on the first social media web page on the social media platform, the social commerce platform generating a display of a second replication link with the electronic commerce shop application to be embedded within a second social media web page on the social media platform designated by the user member, wherein the second replication link references the uniform resource locator for the electronic commerce shop application maintained by the social commerce platform so that it can be used to further replicate the electronic commerce shop application maintained by the social commerce platform on other social media pages of other user members on the social media platform.

17. The system of claim 15, wherein the electronic commerce shop application is configured to provide a display of an electronic commerce shop for one or more products.

18. The system of claim 17, wherein the electronic commerce shop application is configured to provide with the display of the electronic commerce shop a user interactive button to enable a visitor to buy a displayed product.

19. The system of claim 17, wherein the electronic commerce shop application is configured to provide with the display of the electronic commerce shop a user interactive button to enable a visitor to share a favorable indication by the user member for a displayed product.

20. The system of claim 16, wherein the first replication link displayed on the first social media web page on the social media platform references a unique identifier for the owner of said first social media web page, and the second replication link for the designated second social media webpage is assigned a unique identifier for the user member to be designated as owner of said second social media web page.
